(19) United States
(12) Patent Application Publication
(10) Pub. No.: US 2004/0197439 A1
(43) Pub. Date: Oct. 7, 2004

(54) Process and apparatus for wine treatment to reduce its contents of volatile acidity

(76) Inventors: Daniele Fatutto, Venezia (IT); Sergio Salvador, Vittorio Veneto (IT); Antonio Velo, Caerano San Marco (IT)

Correspondence Address: KATTEN MUCHIN ZAVIS ROSENMAN, 575 MADISON AVENUE, NEW YORK, NY, 10022-2585, US

(21) Appl. No.: 10/828,915

(22) Filed: Apr. 21, 2004

Related U.S. Application Data
(63) Continuation of application No. PCT/IT02/00139, filed on Mar. 5, 2002.

(51) Int. Cl. C12C 11/00

(52) U.S. Cl. 426/11

(57) ABSTRACT

Two successive process stages are provided for deacidifying wines, i.e. reducing the volatile acid compounds that are present as a solution in the wine. In the first stage, the solution to be processed (A) is separated into a first concentrate (B) and a first permeate (C), in which the latter comprises said compounds. In the second stage, said first permeate (C) is in turn separated into a second concentrate (F), in which there are included the compounds that are responsible for said volatile acidity, and a second permeate (E) that comprises the solvent. Preferably, said first permeate (C) is at least partially neutralized with high-pH additives between said first and said second stage.

This is a continuation of International Application PCT/IT02/00139 filed Mar. 5, 2002.

### FIELD OF THE INVENTION

The present invention refers to a process and an apparatus aimed at deacidifying wines, i.e. reducing the contents of volatile acid compounds thereof.

### BACKGROUND OF THE INVENTION

Organoleptic qualities and characteristics of wines in general are largely known to be adversely affected by volatile acidity, i.e. the amount of volatile acid compounds, among which acetic acid and ethyl acetate, which are present as a solution in wines, are of particular purport in this connection.

Fully understandable is therefore the effort being made by wine producers in view of achieving a reduction in the volatile acidity of wine, or even eliminating such acidity altogether, to the purpose of optimising the overall quality of theirs products. The use of such products as calcium carbonate, potassium bicarbonate and neutral potassium tartrate directly in the wine in order to achieve a deacidification thereof fails to be effective as far as acetic acid is concerned, since neutralization of weaker acids only, such as in particular tartaric acid, is obtained in this way.

The sole possibility that really exists to effectively reduce the volatile acidity of a wine lies in blending such a wine with another one having a very low volatile acidity.

### SUMMARY OF THE INVENTION

It therefore is a main purpose of the present invention to provide a selective method, i.e. a method that is capable of solely reducing the volatile acidity, in such a manner as to avoid affecting other compounds, especially acid ones, which on the contrary favourably contribute to the final quality of the wine, and furthermore to avoid blending of different wines.

A prior solution to reduce the contents of volatile acidity of a wine was disclosed in U.S. Pat. No. 5,480,665 where a first embodiment consists in a two-stage apparatus, the second stage being performed with the use of anion exchanging resins. Apart from the fact that their use in wine treatment is not allowed for example in the European Union, said resins remove from the wine also some substances which may be desirable for achieving a good quality—see column 2 lines 43-51.

Another known solution was disclosed in U.S. Pat. No. 4,499,117. Actually this solution is specifically directed to reduce the alcohol level of a wine and reduces the total acidity of the wine. As a consequence also the other compounds are reduced or eliminated, especially acid ones, which on the contrary favourably contribute to the final quality of the wine.

At last EP-A-0 460 339 disclosed a two-stage process specifically intended for the treatment of aqueous media such as citrus juice or green coffee extracts but not suitable for wine.

A further purpose of the present invention is to reduce the usage of additives required to this aim, as well as reduce the physical and economic dimensions of the equipment used to reduce the volatile acidity of wine, so as to make it also available to small producers, who usually cannot rely on the availability of huge economic resources, and/or in view of being able to use the invention for processing wines that may be termed as niche products from a marketing viewpoint.

### BRIEF DESCRIPTION OF THE DRAWINGS

The features and advantages of the present invention will be anyway more readily understood from the description of a preferred, although not sole embodiment that is given below by way of non-limiting example with reference to the accompanying drawings, in which:

FIG. 1 shows a diagrammatical view of a continuous separation process for deacidifying wines and also bears the legend of the symbols used to indicate the various media involved in the process as mentioned in this description;

FIG. 2 is a schematic view of the layout of a continuous separation apparatus;

FIG. 3 is a view similar to the one shown in FIG. 1, however relating to a discontinuous separation process;

FIG. 4 is a simplified view of the main section of a portion of the apparatus shown in FIG. 2, where a treatment takes place intended to neutralize the volatile acid substances.

### DETAILED DESCRIPTION OF THE INVENTION

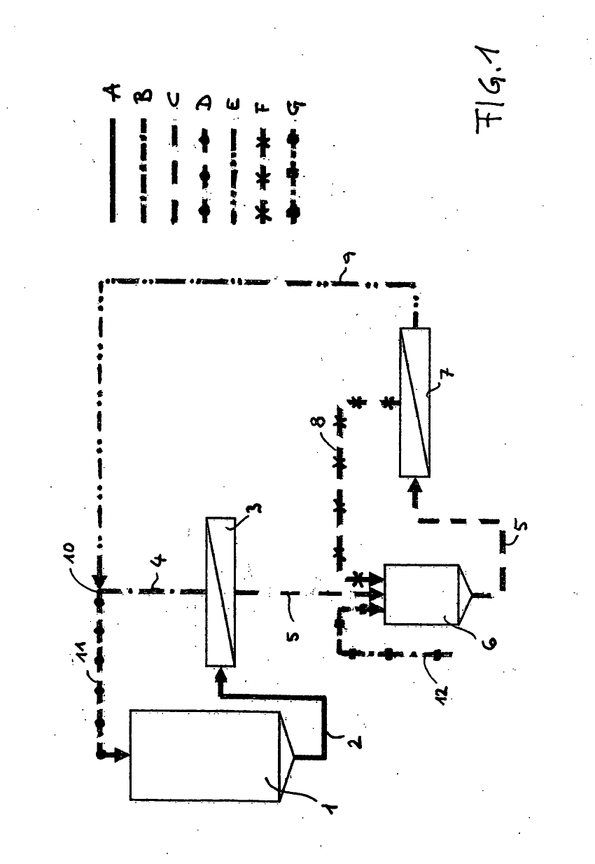

With reference to FIG. 1, the product to be treated—which is generally constituted by wine, but will be referred to as solution A hereinafter since it contains, in form of solutes, the volatile acid compounds to be eliminated—is at the beginning of the process in a storage area 1, namely an initial reservoir, from which it is then transferred via a first delivery line 2 to a process station 3 where a first separation stage takes place. Said station 3, which is also herein referred to as the initial station, comprises at least a membrane which, depending on the size of the molecules of the substances to be removed from the solution A, may either be a reverse-osmosis membrane (i.e. adapted to retain molecules with a size less than 200 dalton), or a nanofiltration membrane (i.e. suitable for molecules with a size of 200 to 1,000 dalton) or a ultrafiltration membrane (i.e. suitable for molecules with a size of 1,000 and 300,000 dalton). In this manner, the solution A is separated into two parts that will be referred to herein as the first concentrate B, which contains most of the solutes that have desirably to be retained, and the first permeate C, which contains the solutes that have on the contrary to eliminated, further to the solvent and a small proportion of the solutes that have desirably to be retained.

Said first concentrate B is let into a first connection line 4 so as to return to the storage area 1 for the reasons that shall be explained to greater detail further on. The first permeate C is in turn transferred, via a second delivery line 5, up to a new process station 7, which is also herein referred to as the final process station, where a second separation process takes place that is much similar to the first one, but is performed under utilization of more selective membrane means so as to be able to obtain, starting from said first permeate C, a second permeate E containing the totality, or almost the totality, of the solvent and the solutes to be retained in the product, and a second concentrate F containing the undesired compounds, i.e. the compounds that have on the contrary to be removed from the final product.

Said second permeate E is delivered via a second connection line 9 to a connection point 10 in view of being caused to mix with the first concentrate B so as to give rise a so-called reconstituted wine D, which is then caused to flow back into the initial reservoir 1 via a return line 11 to again go through the above described process steps until the desired result is eventually achieved.

The second concentrate F is in turn delivered back to the final process station 7. Somewhere along the second delivery line 5 there may be included a reaction stage 6 to which is fed not only with the first permeate C, but also with the second concentrate F and one or more additives with a high pH value, that may be present either in a liquid or a solid form, via a third delivery line 8 and a fourth delivery line 12, respectively. In the case that solid additives are used, said fourth delivery line 12 shown in FIG. 1 shall of course not be intended as being a pipe, but rather as an indication of the use of said additives in this stage of the process.

In this connection, FIG. 4 is shown to illustrate an embodiment of the reaction stage 6, which turns out as being particularly advantageous exactly when solid additives, such as calcium carbonate, are used in the process. The solid additive (or additives, as the case may be) G is filled into an upright container 61, which has a grille 62 as a bottom wall, and which is housed within a tank 63. The first permeate C reaches the tank 63 via the inflow branch 55 of the second delivery line 5, and is caused to percolate through the additive G in such a manner as to release the volatile acid compounds contained therein. Thereupon, downstream of said bottom grille 63, it flows into the outflow branch 56 of the same delivery line 5 after having first moved through a siphon 64.

Along the delivery line 8, the second concentrate F is delivered back to said reaction stage 6, which in this way is adapted to also act as a reservoir supplying the final process station 7.

From the description given above, the peculiar advantages of the present invention can be most clearly inferred, i.e.:

the present invention makes use of just a limited quantity of additives, since the product to be processed solely and only consists of the first permeate C, and therefore is not the totality of the wine. This in turn permits the use of smaller sized equipment and clearly contributes to keep at a low level the production cost of the wines;

there is no risk for also tartaric acid—and other compounds that favourably contribute to the quality of the wine—to be eliminated at the same time as said volatile acid compounds.

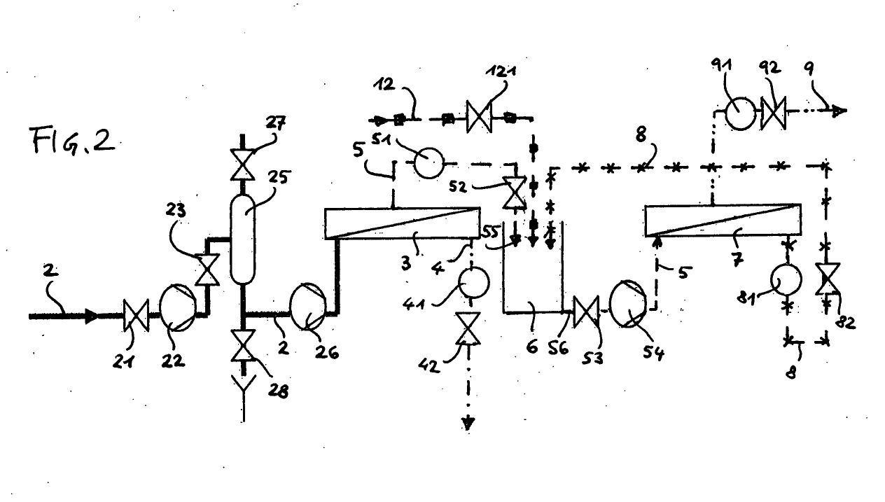

The process according to the present invention can be carried out using a continuous apparatus, the layout of which is illustrated in FIG. 2 where the same reference numerals are used as the ones used in the functional flow-diagram of FIG. 1, whenever possible. This layout also illustrates some so-to-say ancillary equipment which is really neither strictly necessary nor sufficient in view of characterizing the present invention, and for which all those skilled in the art may well be able to devise and find out a different practical implementation. Further to various pressure measurement devices, which are not shown for reasons of greater simplicity, the ancillary equipment shown in the layout of FIG. 2 includes:

along the first delivery line 2 (which feeds the solution A to be processed), a supply valve 21, a first pump 22, a flow-rate adjustment valve 23, a safety prefilter 25, and a second pump 26. Said safety prefilter 25, which is in turn provided with a bleeder valve 28, is used to prevent any damage to the membranes that are used as a part of the two process stations 3, 7 by possible solid particles present in the solution A;

along the first connection line 4 (in which, downstream of the initial process station 3, where the first separation stage takes place, there flows the first concentrate B so as to reach the connection point, which is not shown here for reasons of greater simplicity, with the second permeate E), a flow-rate meter 41 and a pressure adjustment valve 42;

along the second delivery line 5 (in which there flows the first permeate C, and which is shown in this preferred embodiment to pass through the reaction column 6), a flow-rate meter 51 and a first adjustment valve 52 ahead of the inlet 55 into the reaction column 6, a second adjustment valve 53 and a third delivery pump 54 between the outlet 56 of the reaction column 6 and the inlet of the final process station 7, where the second separation stage is carried out;

along the third delivery line 8 (along which there flows, from the final process station 7, the second concentrate F to reach the reaction column 6), a flow-rate meter 81 and a pressure adjustment valve 82;

along the second connection line 9 (in which there flows the second permeate E before mixing up with the first concentrate B at the above mentioned connection point which, as already pointed out, is not shown in FIG. 2), a flow-rate meter 91 and a valve 92;

along the fourth delivery line 12, an adjustment valve for the additive or additives G prior to the inlet thereof into the reaction column 6.

In view of practically achieving the same quality results that can be reached with the use of a continuous apparatus such as the one illustrated in FIG. 2, the process according to the present invention may as an alternative be carried out in a discontinuous manner in an apparatus which, as compared with the above described one, has the additional advantage of needing a lower economic investment, since a definitely smaller extent of means are used in such an apparatus, so that the latter is particularly suited for use by small-scale wine producers.

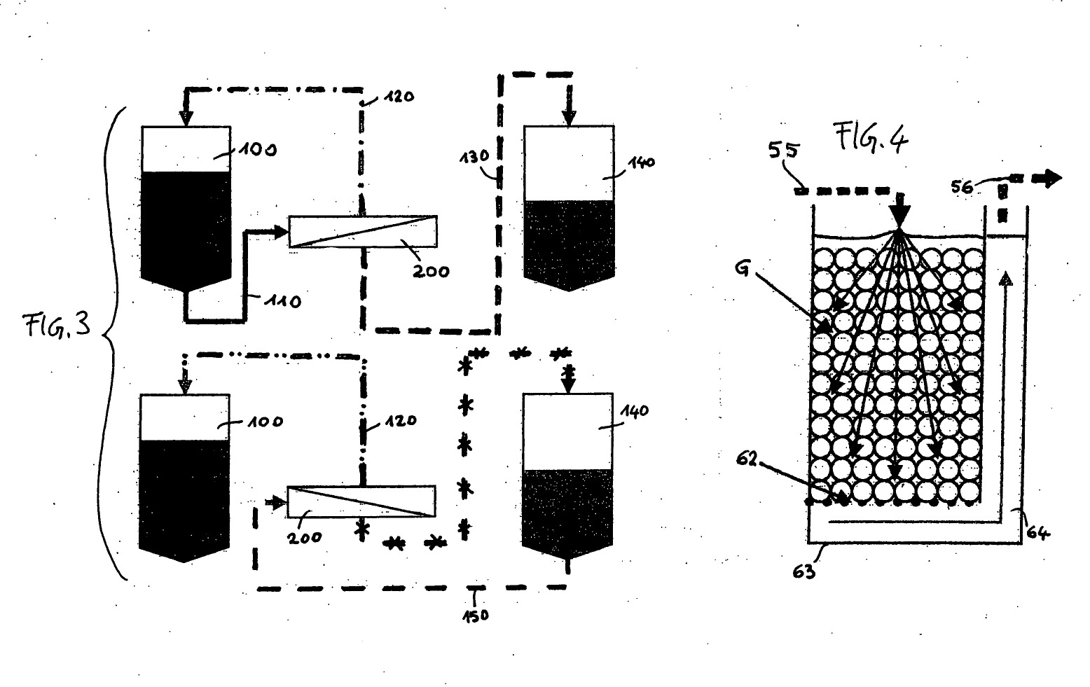

An example of a discontinuous apparatus in this sense is schematically illustrated in FIG. 3, in which the same graphical symbols are used as in the Figures illustrating a continuous apparatus to indicate the various process media. The possibility exists in this of using only one process station for carrying out both the first and the second filtration stage, obviously according to a different timing and possibly under utilization of different filtration membranes.

The first separation stage which the solution A, stored in a first reservoir 100 and delivered via a first delivery line 110, is caused to undergo at the process station 200, produces the first concentrate B, which then flows back into the same reservoir via the return line 120, and the first permeate C, which is in turn delivered via the connection line 130 to a second reservoir 140 where it is collected and temporarily stored until the second separation stage takes place.

The second separation stage, which is also performed in said process station 200, solely concerns said second permeate C which reaches said process station 200 via the delivery line 150, after the temporarily storage in said second reservoir 140, where it can also be mixed with the additives. Downstream of the process station 200, the resulting second permeate E is conveyed via the return line 120 into the first reservoir 100—which therefore acts also as a storage facility for the processed wine, i.e. the final product of the process according to the present invention—whereas the resulting second concentrate F is conveyed back via the connection line 130 into the second reservoir 140.

The data set forth in the following Table 1 summarize the results of three wine deacidification test runs, the first one of which was performed without the use of any additive (and therefore without any intermediate step between the two separation stages), while the remaining two ones have been carried out under utilization of two different additives between the two separation stages to process the first permeate C.

TABLE 1
Experimental results

| | | | | |
|---|---|---|---|---|
| | Total | Volatile | Acetic | Tartaric |
| | acidity | acidity | acid | acid |
| Sample | [g/l] | [g/l] | [g/l] | [g/l] |

Test run no. 1 - Additive none

| | | | | |
|---|---|---|---|---|
| Initial wine (A) | 7.38 | 2.00 | 1.45 | 1.07 |
| First permeate (C) | 0.70 | 0.56 | 0.56 | 0.40 |
| Second permeate (E) | 0.55 | 0.43 | 0.38 | Traces |
| Reconstituted wine | 7.12 | 1.85 | 1.45 | 0.80 |

Test run no. 2 - Additive (G): sodium hydroxide

| | | | | |
|---|---|---|---|---|
| Initial wine (A) | 7.38 | 2.00 | 1.45 | 1.07 |
| First permeate (C) | 0.70 | 0.56 | 0.56 | 0.40 |
| Second permeate (E) | 0.00 | 0.03 | 0.03 | 0.41 |
| Reconstituted wine | 7.18 | 1.32 | 1.27 | 1.11 |

Test run no. 3 - Additive (G): sodium bicarbonate

| | | | | |
|---|---|---|---|---|
| Initial wine (A) | 7.38 | 2.00 | 1.45 | 1.07 |
| First permeate (C) | 0.70 | 0.56 | 0.56 | 0.40 |
| Second permeate (E) | 0.00 | 0.43 | 0.08 | 0.41 |
| Reconstituted wine | 7.18 | 1.86 | 1.31 | 1.04 |

As shown by these experimental data, a reduction in volatile acidity, which goes to as far as 34% in test run no. 2, is in all cases reached, while it is only with the use of additives that the tartaric acid contents remains substantially unaltered.

For a correct understanding of the data displayed in Table 1, it is reminded that acetic acid falls into the category of volatile compounds that must be eliminated, while tartaric acid is an essential component of wine.

It shall finally be appreciated that, within the scope of the present invention as recited in the appended claims, the aforedescribed process and/or apparatus may be implemented according to other embodiments differing from the above-described ones.

1. A process for the deacidification of wine, i.e. for the reduction of the contents of volatile acid compounds that are present as a solution in said wine, comprising the following steps in a sequence:
a first stage in which the solution to be processed (A) is separated into a first concentrate (B) and a first permeate (C), in which first permeate (C) there are included the compounds that are responsible for said volatile acidity of the wine, further to at least most of the solvent; and
a second stage in which said first permeate (C) is in turn separated into a second concentrate (F), in which there are included the compounds that are responsible for said volatile acidity of the wine, and a second permeate (E) that comprises the solvent.

2. A process according to claim 1, further comprising, between said first and said second stage, a third stage in which said second permeate (E) joins again said first concentrate (B) and is mixed up again with the initial solution (A).

3. A process according to claim 1, further comprising, between said first and said second stage, an intermediate stage in which substances (G) are added to said first permeate (C) that are adapted to at least partially neutralize said compounds that are responsible for the volatile acidity of the wine.

4. A process according to claim 3, wherein said substances (G) that are added to said first permeate (C) are sodium, potassium or calcium compounds, such as in particular hydroxides, carbonates, tartrates or acetates.

5. A process according to claim 1, wherein during said first and said second stages, the initial solution (A) and the first permeate (C), respectively, are held under pressure.

6. A process according to claim 1, wherein said process is carried out in a continuous manner without any solution of continuity.

7. A process according to claim 1, wherein said process is carried out in a discontinuous manner.

8. An apparatus for the deacidification of wine, said deacidification occurring through a two-stage process comprising a first stage in which the solution to be processed (A) is separated into a first concentrate (B) and a first permeate (C), in which first permeate (C) there are included the compounds that are responsible for said volatile acidity of the wine, further to at least most of the solvent, and a second stage in which said first permeate (C) is in turn separated into a second concentrate (F), in which there are included the compounds that are responsible for said volatile acidity of the wine, and a second permeate (E) that comprises the solvent, said apparatus comprising:
at least one process station (3, 7) having membrane means for separation of the compounds that are responsible for the volatile acidity of the wine, and means (12) to add solid or liquid additives (G) to the permeate (C) resulting from the first stage of the said two-stage process.

9. An apparatus according to claim 8, further comprising a continuous apparatus consisting of an initial process station (3) where said first stage is performed, a final process station (7) where said second stage is performed and an intermediate reaction station (6) consisting of:
an upright container (61) adapted to be filled with the said additives (G),
a grille (62) constituting the bottom wall of said container (61),
and a tank (63) for housing the same container and a siphon (64),
wherein the said tank (63) has an inflow branch (55) for the permeate (C) coming from the said initial process station (3) and an outflow branch (56) downstream of the said siphon (64) for conveying the permeate through to the said final process station (7) upon undergoing the desired treatment imparted by the contact with said additives (G).

10. An apparatus according to claim 9, further comprising pump means (22, 26) adapted to keep the solution to be processed (A) under pressure as it is being treated in the said initial process station (3).

11. An apparatus according to claim 9, further comprising pump means (54) adapted to keep the said first permeate (C) under pressure as it is being treated in the said final process station (7).

12. An apparatus according to claim 8, further comprising, ahead of said initial process station (3), filter means (25) that are adapted to prevent the membrane means that are a part of the two process stations (3, 7) to be damaged by solid particles that may be present in the solution to be processed (A).

13. An apparatus according to claim 8, wherein said apparatus is a discontinuous apparatus where a single process station (200) constitutes in a first stage said initial process station and, in a second stage, under utilization of filtering membranes provided with a different selectivity as compared with the ones used in said first stage, constitutes the final process station, in which said apparatus further comprises: a first reservoir (100), which in the first stage collects and stores the solution to be processed (A) for delivery to said process station (200) and, in the second stage, receives the wine processed in the same process station; a second reservoir (140), which during said first stage receives the first permeate (C) and, during said second stage, supplies said first permeate (C) to said single process station (200) upon undergoing the desired treatment imparted by the contact with said additives (G).
